(19) United States
(12) Patent Application Publication
(10) Pub. No.: US 2003/0127170 A1
(43) Pub. Date: Jul. 10, 2003

(54) Method for protecting a tire against ozone

(76) Inventors: Alain Cottin, Clermon-Ferrand (FR); Georges Peyron, Riom (FR)

Correspondence Address: BAKER & BOTTS, 30 ROCKEFELLER PLAZA, NEW YORK, NY, 10112

(21) Appl. No.: 10/314,702

(22) Filed: Dec. 9, 2002

Related U.S. Application Data
(63) Continuation of application No. PCT/EP01/06356, filed on Dec. 13, 2001.

(51) Int. Cl. B29D 30/72; B60C 13/00; B60C 11/00; B60C 1/00; B60C 13/04; C08J 7/04

(52) U.S. Cl. 152/524; 156/116; 152/525; 152/450; 152/209.5; 156/110.1

(57) ABSTRACT

The present invention relates to a method for anti-ozone protection of at least a part of the outer surface of a vulcanized tire, where the composition of the tire is based on essentially unsaturated dienic elastomers. The present method comprises: (1) subjecting the surface of the vulcanized tire to a treatment in order to polarize and functionalize the elastomers of the surface; (2) applying at least one layer comprising an aqueous polyurethane dispersion to this treated surface; and (3) allowing this layer to dry until a protective coating is formed. The present invention further relates to a tire comprising an anti-ozone protective coating, where the protective coating is formed according to the method described above.

### CROSS-REFERENCE TO RELATED APPLICATIONS

This application is a continuation of International Application Number PCT/EP01/06356, published in French on Dec. 13, 2001 as International Publication Number WO 01/94453 A1 and filed on Jun. 5, 2001, which claims priority to French Patent Application Number 00/07313, filed on Jun. 7, 2000.

### FIELD OF THE INVENTION

The present invention relates to the surface condition of the outer surface of tires and, more particularly, to their protection against ozone and the improvement of their appearance.

### BACKGROUND OF THE INVENTION

Vulcanized rubber compositions based on dienic polymers that have ethylenic double bonds in their main chain are very sensitive to the effects of ozone. When an article made from such an elastomeric composition is subjected to a strain in the presence of ozone, the detrimental effect of ozone leads to the appearance of surface cracking oriented perpendicularly to the direction of the strain. As this strain persists or each time the strain occurs, the cracking increases and can cause complete rupture of the article.

In order to limit this degradation, it is customary for elastomeric compositions to include anti-ozone chemical compounds as well as waxes. The anti-ozone chemical compounds slow the formation and propagation of the cracks under static and dynamic stress conditions. The waxes provide extra static protection by forming a protective surface coating.

Generally, these methods of combating degradation due to ozone have proven to be effective. Unfortunately, however, the most effective anti-ozone compounds, as well as the waxes, tend to migrate to the surface of the articles and thereby mark them or modify them. In particular, the surface migration of the waxes modifies the external appearance of the surfaces of the elastomer compositions by rendering them dull and grey. This phenomenon is referred to as wax “efflorescence”.

These migrations are problematic on white or colored parts of the tires, but also affect black-colored tires or parts of tires, the outer surfaces of which will change from a lustrous appearance to a dull and grey appearance. In order to preserve the surface appearance of the tires, the proportion of these compounds in the rubber mixtures, and consequently their effect, is therefore limited. Furthermore, the proportions of waxes and anti-ozone compounds are also limited by mixture cohesion problems.

Other solutions have been proposed, such as the one described in the patent application EP 0 728 810, which consists of depositing, on the vulcanized tire surface to be protected, one or more layers of an anti-ozone and anti-migration protective coating consisting of an aqueous composition comprising a polymer selected from the group of acrylic, methacrylic and vinyl esters, and a constituent comprising a hydrophilic silica and a polymer whose monomer is selected from acrylic, methacrylic and vinyl monomers. Such a coating is particularly advantageous if it is deposited on the tire once it has been vulcanized, which avoids all the strains and modifications associated with the movements of raw compositions during curing.

However, such a composition adheres poorly to a rubber surface. Therefore, the composition described in patent application EP 0 728 810 is deposited in a layer having a very small thickness, preferably from 3 to 15 μm, which renders it difficult to delaminate in spite of the poor adhesion. The direct consequence of the thinness of the coating is found to be its short life.

The present invention, therefore, provides a tire having a novel coating for protection against ozone, which makes it possible to overcome these and other drawbacks.

### SUMMARY OF THE INVENTION

It has been discovered that certain polyurethanes can constitute a protective anti-ozone coating for a tire. This coating advantageously may be deposited on a vulcanized tire after a treatment of the surface in question, where this treatment allows the polyurethane to adhere satisfactorily to the surface of the tire and prevents there being any limitation on the thickness of the coating.

Thus, the present invention relates to a tire, of which at least a part of the rubber outer surface based on essentially unsaturated dienic elastomers is covered with a coating for protection against ozone. This coating comprises at least one layer, in contact with the air, consisting of polyurethane prepared from a polyol selected from the group consisting of aliphatic polyethers, aliphatic polyesters, and polyethers and polyesters whose main chain is semi-aromatic. The bond between the elastomer and the polyurethane is formed by way of the polar functions of the elastomer, and the coating comprises surfactants. The polar functions located at the surface of the elastomer are even more effective when they have at least one mobile hydrogen capable of reacting with the coating to form covalent bonds.

Advantageously, the polyurethane has a glass transition temperature of less than or equal to −20° C. and an elongation at break of greater than or equal to 100%. The glass transition temperature of a polymer is the temperature at which the mechanical behavior of the polymer changes from a glassy, rigid and brittle behavior to a rubber-like behavior.

This layer therefore makes it possible to form a continuous and flexible coating, which adheres to the surface of the tire. The presence of this coating counteracts the degradation due to ozone. The rubber-like behavior of the coating of the present invention makes it possible to withstand all the deformations experienced after a tire is manufactured, particularly when inflating it and during subsequent use. Furthermore, this coating has the advantage of preventing migration of the waxes towards the surface by a barrier effect, therefore avoiding the waxes' efflorescence.

This coating also provides a tire with an advantageous aesthetic appearance by acting as a varnish whose gloss can be varied by adding, in a known manner, an additive such as hydrophilic silica (in proportions ranging from 5 to 30 parts per hundred parts of polyurethane). Such an unpigmented varnish is transparent, and this varnish: (1) can be applied to a black tire without the migration of the oxidized derivatives of the antiozonants being problematic because the latter remain in solution in the varnish layer, virtually without the blackness of the tire (seen by transparency) being modified; or (2) can be applied to a colored tire part, which, in this case, need not contain antiozonants, which give marking (strongly colored) oxidized derivatives. Moreover, in order to mask the color irregularities at the surface of a black tire, it may be advantageous to color the varnish black by adding either a black organic pigment or carbon black.

The present invention also provides a method for protecting the outer surface of a tire against ozone and for improving the appearance of the tire, which is simple to implement. The present method for anti-ozone protection of at least a part of the outer surface of a tire, whose composition is based on essentially unsaturated dienic elastomers, comprises the following stages:

(a) subjecting the surface of a vulcanized tire to a treatment in order to polarize and functionalize the elastomers of this surface;

(b) applying to this treated surface at least one layer consisting of an aqueous polyurethane dispersion; and

(c) allowing this layer to dry until a protective coating is formed.

Advantageously, the aqueous polyurethane dispersion is applied at ambient temperature.

Therefore, the present method may be implemented easily to protect a vulcanized tire, and the method does not require any heating operation, even though it is possible to accelerate the drying operations by a moderate increase of the temperature at the surface of the tire. Other advantages and characteristics of the present invention will become apparent on reading an exemplary embodiment of a tire according to the invention and the method described herein.

### DETAILED DESCRIPTION OF THE INVENTION

The method of the present invention is intended to protect a tire against ozone and to improve the appearance of the surface of a tire whose composition is based on essentially unsaturated dienic elastomers.

As is known, the term “dienic” elastomer or rubber is used to denote an elastomer originating at least in part (i.e., a homopolymer or a copolymer) of diene monomers (monomers carrying two conjugated or unconjugated carbon-carbon double bonds).

In general, the term “essentially unsaturated” dienic elastomer is used herein to denote a dienic elastomer originating at least in part from conjugated diene monomers, having a proportion of structural units or blocks of dienic origin (conjugated dienes) which is more than 15% (% by mole). For example, dienic elastomers such as butyl rubbers or copolymers of dienes and alpha-olefins such as EPDM (ethylene-propylene-diene terpolymer) do not fall within the above-described definition and may be classified as “essentially saturated” dienic elastomers (having a low or very low proportion of structural units of dienic origin, which is always less than 15%).

The method of the present invention comprises first depositing, on a vulcanized tire outer surface to be protected, a solution comprising a functionalizing agent in order to functionalize the dienic elastomers and subsequently to permit the adhesive bonding of an aqueous polyurethane suspension according to the invention. The tire may or may not be fitted and inflated prior to these operations.

The above-mentioned functionalizing agent is preferably selected from the group consisting of alkali metal and alkaline-earth metal hypochlorites added to hydrochloric acid, in particular sodium, potassium or calcium hypochlorites. In other preferred embodiments, the functionalizing agent may be trichloroisocyanuric acid (TIC), which makes it possible to carry out chlorination and oxidation at the surface of the rubber mixture.

The functionalizing agents are in solution. For example, the hypochlorite functionalizing agents are in a solvent such as water, whereas when TIC is used, it is in an anhydrous solvent such as ethyl acetate. The concentration of the functionalizing agents in solution ranges from 1 to 5 wt. %, and both of the mentioned solvents have the advantage of readily evaporating thereafter.

This treatment makes it possible to polarize and functionalize the rubber surface so as to permit exceptional adhesion of the polyurethane layer. This treatment also permits the formation of covalent bonds between the polyurethane and the essentially unsaturated dienic elastomers of the rubber mixture because of the polar functions which are created on the dienic elastomers. TIC also makes it possible to improve the wetting, which further promotes the adhesion of the polyurethane layer.

It is possible to deposit such a solution of a functionalizing agent at ambient temperature, and the application of the solution may be carried out by all known means, in particular with a brush, a roller or by spraying with a gun. The solution is then allowed to dry for about 10 to 30 minutes so that the chemical reaction with the rubber surface can take place and so that the solvent evaporates. To accelerate this drying operation, the surface of the tire may be heated, although it is necessary to ensure that the surface temperature does not exceed 60° C. so as to prevent the polar functions formed at the surface from migrating towards the inside of the rubber mixture, which would make the polar functions no longer accessible or available to bond with the polyurethane.

A thin layer of an aqueous polyurethane dispersion is then applied to the surface treated in the above-described way, by any suitable means as in the case of the treatment above. The use of an aqueous dispersion of polyurethane is particularly advantageous. This is because an aqueous dispersion makes it possible to deposit the polyurethane by any selected means, in particular by spraying, which has the advantage that an extremely thin layer can be formed if desired. Also, the deposition of an aqueous dispersion of polyurethane provides a very uniform distribution of the polyurethane molecules in the layer which is formed and provides a reaction which does not require the input of heat.

Despite these advantages, the use of such an aqueous dispersion of polyurethane runs contrary to the standard assumptions of the person skilled in the art. This is because it is typically the free isocyanate groups carried by polyurethane which make it possible to create a bond between a polar surface and polyurethane, whereas the free isocyanate groups impair the stability of polyurethane in water. Thus, it seems quite logical that one might preclude the possibility of using an aqueous dispersion of polyurethane since the problem of the polar surface-polyurethane bond already constitutes a difficulty to be overcome.

However, it has unexpectedly been found that with self-crosslinkable polyurethanes, such as those described in the communication “New polymer synthesis for (self) crosslinkable urethanes and urethanes/acrylics” presented by Ad. OVERBEEK EUROCOAT 97 at Lyon Eurexpo, Sep. 23-25, 1997, which can crosslink by the formation of azomethine or by self-oxidation, the mere presence of the chlorinated or oxidized polar functions is sufficient to permit adhesion of the polyurethane even without the free isocyanate groups and to permit retention of the polyurethane in spite of the stresses and strains experienced by the tire, as is shown by the Examples set forth below. Moreover, such polyurethanes can be used in the form of an aqueous dispersion.

It is possible, nevertheless, to employ polyurethanes containing free isocyanate groups if the latter are protected at the core of the particles of the aqueous dispersions. It may be noted that coatings such as those described in the patent application EP 0 728 810 do not react with polar functions, and hence that such a surface treatment has no advantage for such compositions.

The polyurethane used in the dispersion is formed from a polyol selected from the group consisting of aliphatic polyethers, aliphatic polyesters, and polyethers and polyesters whose main chain is semi-aromatic, which provides the coating with its inertness to ozone. This polyurethane also has a glass transition temperature of less than or equal to −20° C. and an elongation at break of greater than or equal to 100%, so as to present a rubber-like behavior and an elasticity compatible with the rubber-like behavior and elasticity of the tire in order to withstand the stresses experienced by the latter. A polyurethane having an elongation at break of greater than 200% is used in certain preferred embodiments of the present invention.

Among the polyurethanes that may be used according to the present invention, mention may be made of the polyurethanes obtained from:

(1) polyol with molar mass between 500 and 4000 g based on a polyester such as polyethylene adipate, a polycarbonate, a polycaprolactone or based on a polyether such as polypropylene glycol, a polytetramethylene glycol or a polyhexamethylene glycol;

(2) a polyisocyanate with functionality 2 such as toluene diisocyanate (TDI), diphenyl methane diisocyanate (MDI), dicyclohexyl methane diisocyanate, cyclohexyl diisocyanate or isophrone diisocyanate; a polyisocyanate with functionality 3 such as a triisocyanate obtained by trimerization of one of the diisocyanates mentioned above; or a polyisocyanate with functionality between 2 and 3 such as a liquid polyisocyanate derived from MDI;

(3) and optionally, an extender such as a diamine or a diol dissolved in the aqueous phase of the polyurethane dispersion.

Whatever polyurethane is selected, it is necessary to provide for the presence of surfactants in the aqueous dispersion in order to improve, in particular, the stability of the emulsion which is formed. These surfactants may be added to the dispersion. For example, polar groups having an anionic character such as carboxylates, sulfonates, sulfates or phosphates are particularly advantageous. However, other surfactants may be employed and other surfactants may even be directly carried by the chain of the polyurethane.

The polyurethane concentration in the aqueous polyurethane dispersion is preferably between 10 and 50%, depending on the location of the surface of the tire to be protected. Polyurethane concentrations below 10% may be too low to obtain the expected effects, while concentrations above 50% may cause the dispersion to become very viscous and difficult to apply. The selection of the concentration depends on whether or not the surface to be protected needs a large final coating thickness, in which case the highest concentration will preferably be selected in order to reduce the number of layers to be applied, and vice versa.

The layer is then allowed to dry until the polyurethane has completely reacted with the reactive surface functions of the rubber mixture, in order to adhere to the treated surface, and until the water has totally evaporated, hence forming the protective coating. At ambient temperature, the drying time is typically about one hour, and this time can be reduced to a few minutes by a heating operation. For example, such a heating operation may include circulating hot air or radiant heating, as long as the surface temperature of the tire is kept below 60° C.

In order to obtain the desired coating thickness after drying the aqueous dispersion, it may be advantageous to apply the polyurethane solution in one or more successive layers. Good results typically are obtained with dry coatings having a thickness of greater than or equal to 5 μm. However, the desired coating thickness will vary depending on the surface on which the coating is applied. For instance, in the case of the groove bottoms of the profiles of the treads of aircraft tires, which crack rapidly under the effect of ozone even when at rest because of the large permanent strains due to the inflation pressure, a coating thickness of between 100 μm and 500 μm will be preferred. Conversely, in the case of the outer surface of the sidewalls of a tire, a thickness of between 5 μm and 50 μm will be sufficient.

Of course, the protective coating of the present invention cannot be effective on the parts of the tire in permanent contact with the ground. Hence, if it is deposited on the entire surface of the tread, the coating makes it possible to protect the tread prior to its use and continues its anti-ozone effects on the parts of the tread which are not in contact with the ground, in particular, the hollow (groove) bottoms of the profiles. The coating part covering the crests of the profiles directly in contact with the ground will be rapidly destroyed since it is subjected to wear.

A description is given below of an example of a tire having a coating according to the present invention, where the coating is applied to protect the groove bottoms of the profiles of the tire's tread. This example in no way constitutes a limitation on which surfaces of a tire may be protected using such a coating.

The vulcanized tire comprises a tread whose outer surface, which has been functionalized in order to have reactive polar functions at its surface, is covered with a polyurethane layer adhering to this surface via its covalent bonds with the functions which have been created. The polyurethane layer therefore constitutes a coating for protection against ozone comprising an aqueous polyurethane dispersion.

This coating covers the entire surface of the tread, that is to say, the bottoms of the profiles as well as the crests of the profiles that are in direct contact with the ground. As mentioned above, it is clear that the coating covering the crests of the profiles will disappear very rapidly during running because of the wear of the tread, whereas the coating remains permanent on the profile bottoms. The following Examples are meant to further illustrate the present invention, without limiting it.

### EXAMPLES

In these Examples, the properties of the compositions are evaluated as follows:

The “static endurance” is a test of the mechanical strength of the coating, where the tire is left for 96 hours under 40 pphm, parts per hundred million, of ozone.

The “dynamic endurance” is a test of the mechanical strength of the coating under dynamic stress, specifically, 6000 km on a rolling assembly with an imposed deflection of 30% at 50 km/h under 40 pphm of ozone. This test imposes a dynamic surface deformation on the sidewalls of about 15% extension.

The “aircraft test” is a test of the mechanical strength of the coating under dynamic stress during 8 “runs” with a force Z of 30470 daN being exerted on the tire, 2 “runs” with a force 1.2 Z and 50 “takeoffs” with a force Z and 1 “takeoff” with a force 1.5 Z. The “running” corresponds to a distance travelled of 11 km at 65 km/h and the “takeoff” corresponds to a minimum distance of 3.5 km at a speed of 380 km/h.

The “appearance” testing involves visual inspection (with the naked eye) of the aesthetic appearance of the coating.

The compositions used in these Examples are as follows:

Solution A: a dispersion (at 38% strength) of polyurethane prepared from an aliphatic polyester having an elongation ratio of less than 50%, commercially available from the company AVECIA sas, under the name NeoRez R-560.

Solution B: a dispersion (at 35% strength) of polyurethane prepared from an aliphatic polyester having an elongation ratio of greater than 700%, commercially available from the company AVECIA sas, under the name NeoRez R-550.

Solution C: a dispersion (at 40% strength) of polyurethane prepared from an aliphatic polyether having an elongation ratio of 650%, commercially available from the company AVECIA sas, under the name NeoRez R-987.

TIC solution: Trichloroisocyanuric acid at 3% strength in ethyl acetate.

### Example 1

In this Example, a passenger-car tire of size 185/65 R14 inflated to a pressure of 2 bar was used for dynamically testing the effectiveness of a coating according to the invention. The surface of one sidewall half of this tire was left in its condition after vulcanization of the tire, and this surface served as the control surface. The surface of the other sidewall half, the coated surface, was treated before inflation with a TIC solution and then dried. Subsequently, Solution A was applied to this half after dilution to obtain a concentration of 20%. After drying, the polyurethane layer obtained was approximately 7 μm thick. The tire was then fitted on a rim and was inflated to a pressure of 2 bar.

After the dynamic endurance test, the appearance of the sidewalls of the tire was observed. The control surface was completely cracked and had a dull and grey coloration, showing that wax efflorescence had taken place. The coated surface kept its glossy coating, although some deterioration appeared, which showed that the elongation ratio of the polyurethane used was insufficient. Despite the lack of flexibility of the coating tested in Example 1, its effectiveness against ozone and is propensity for preserving the appearance of the surface of the tire were clearly shown.

### Example 2

In this Example, an aircraft tire of size 50*200 R22 was used to compare the effectiveness of coatings according to the invention in comparison to an unprotected control. Three groove bottoms of the profiles of the tread of the tire were covered as follows:

Groove Bottoms 2 had no coating and acted as the control groove bottoms.

Groove bottoms 2B: the TIC solution was applied and then, after drying, Solution B was deposited in order to obtain a coating thickness after drying of approximately 100 μm.

Groove bottoms 2C: identical to Groove Bottoms 2B, but Solution C was used rather then Solution B.

After inflating the tire fitted on a rim to 16 bar, the results obtained from the static endurance test were reported in Table 1 below:

TABLE 1

| Groove Bottoms | 2 | 2B | 2C |
|---|---|---|---|
| Surface Treatment | (None) | TIC solution | TIC solution |
| Coating | (None) | Solution B | Solution C |
| Appearance After | Highly cracked | No degradation | No degradation |
| Static Endurance | | | |
| Test | | | |

It was observed that Groove Bottoms 2, which did not have any coating and which corresponded to a control, were completely cracked, even under static conditions, because of the inflation pressure of the tires. The permanent deformations were very large and reached 100% in places, showing that the action of the ozone was very effective on Groove Bottoms 2.

Conversely, on Groove Bottoms 2B and 2C, whose surfaces had been activated and covered with coatings based on Solutions B and C, respectively, according to the invention, it was observed that no degradation appeared. Thus, there was no delamination of the coating, and no cracking was observed. Groove Bottoms 2B and 2C, therefore, were protected effectively against the effects of ozone, in the case of a polyurethane based either on an aliphatic polyester or an aliphatic polyether.

### Example 3

In this Example, a tire identical to the one described in Example 2 above was used to carry out an aircraft test and to study the influence of the dynamic deformations of such a tire, during running and takeoff, on the endurance of a coating according to the invention. The groove bottoms of the profiles of the tread of the tire were prepared as follows:

Groove Bottoms 3B and 3C were identical to Groove Bottoms 2B and 2C, respectively, of Example 2.

Groove Bottoms 3′B and 3′C were not subjected to the surface treatment operation with the TIC solution, but were covered with a coating having a thickness of approximately 100 μm of polyurethane obtained from the respective deposition of Solutions B and C.

The results obtained during this Example are reported in Table 2 below.

TABLE 2

| Groove | | | | |
|---|---|---|---|---|
| Bottoms | 3B | 3C | 3’B | 3’C |
| Surface | TIC solution | TIC solution | (None) | (None) |
| Treatment | | | | |
| Coating | Solution B | Solution C | Solution B | Solution C |
| Appearance | No | No degradation | Cracked; | Cracked; |
| After | degradation | | Coating | Coating |
| Dynamic | | | | |
| Endurance | | | delaminated | delaminated |
| Test | | | | |

It was observed that the coatings according to the invention of Groove Bottoms 3B and 3C lasted under normal atmosphere and withstood delamination in the dynamic endurance tests, whereas the coatings covering Groove Bottoms 3′B and 3′C became delaminated under the effects of the centrifugal force and therefore no longer protected the groove bottoms, which cracked under the effects of the ozone present in the atmosphere.

The polyurethane coatings according to the invention, therefore, provide anti-ozone protection under both static and dynamic strains. However, in order to maintain the bond between these coatings and the rubber surface to be protected, it is necessary to subject the rubber surface, before the coating is deposited, to a functionalizing treatment which subsequently permits the creation of covalent bonds with the coating.

We claim:

1. A tire having a rubber outer surface based on essentially unsaturated dienic elastomers, wherein at least a part of the rubber outer surface is covered with a coating for protection against ozone, wherein said coating comprises at least one layer in contact with the air, wherein the layer comprises surfactants and polyurethane prepared from a polyol selected from the group consisting of aliphatic polyethers, aliphatic polyesters, and polyethers and polyesters whose main chain is semi-aromatic, and wherein bonds between the elastomer and the polyurethane are formed as a result of polar functions on the elastomer.

2. The tire of claim 1, wherein the surfactants comprise functional groups carried by the chain of the polyurethane.

3. The tire of claim 1, wherein the surfactants comprise anionic polar groups.

4. The tire of claim 1, wherein the coating comprises azomethine molecules.

5. The tire of claim 1, wherein the polyurethane has a glass transition temperature of less than or equal to −20° C. and an elongation at break of greater than or equal to 100%.

6. The tire of claim 5, wherein the elongation at break of the polyurethane is greater than 200%.

7. The tire of claim 1, wherein the polar functions are chlorinated functions or oxidized functions.

8. The tire of claim 1, wherein the layer comprising polyurethane has a thickness of greater than or equal to 5 μm.

9. The tire of claim 8, wherein the layer comprising polyurethane has a thickness of between 100 μm and 500 μm.

10. The tire of claim 1, wherein the part of the rubber outer surface of the tire covered with the coating for protection against ozone is the outer surface of the tread of the tire.

11. The tire of claim 1, wherein the part of the rubber outer surface of the tire covered with the coating for protection against ozone is the surface of the bottoms of the profile grooves of the tread of the tire.

12. The tire of claim 1, wherein the part of the rubber outer surface of the tire covered with the coating for protection against ozone is the surface of one of the sidewalls of the tire.

13. A method for protecting at least part of a rubber outer surface of a vulcanized tire from ozone, wherein the rubber outer surface is based on essentially unsaturated dienic elastomers, said method comprising: (1) subjecting the surface of the vulcanized tire to a treatment in order to polarize and functionalize the elastomers of the surface; (2) applying at least one layer comprising an aqueous polyurethane dispersion to the treated surface; and (3) allowing the layer to dry until a protective coating is formed.

14. The method of claim 13, wherein the aqueous polyurethane dispersion is applied at ambient temperature.

15. The method of claim 13, wherein the layer comprising the aqueous polyurethane dispersion is dried at ambient temperature.

16. The method of claim 13, wherein the layer comprising the aqueous polyurethane dispersion is dried using heat such that the temperature of the surface on which the protective coating is formed does not exceed 60° C.

17. The method of claim 13, wherein the treatment of the surface of the vulcanized tire comprises depositing a functionalizing agent in a solvent on the surface and drying the surface until the solvent evaporates.

18. The method of claim 17, wherein the functionalizing agent in the solvent is deposited on the surface at ambient temperature.

19. The method of claim 17, wherein the functionalizing agent in the solvent is dried at ambient temperature.

20. The method of claim 17, wherein the functionalizing agent in the solvent is dried using heat such that the temperature of the surface on which the functionalizing agent has been deposited does not exceed 60° C.

21. The method of claim 17, wherein the functionalizing agent is selected from the group consisting of alkali metal hypochlorites added to hydrochloric acid and alkaline-earth metal hypochlorites added to hydrochloric acid.

22. The method of claim 21, wherein the functionalizing agent is selected from the group consisting of sodium, potassium and calcium hypochlorites added to hydrochloric acid.

23. The method of claim 17, wherein the functionalizing agent is trichloroisocyanuric acid.

24. The method of claim 23, wherein the trichloroisocyanuric acid is dissolved in ethyl acetate.

25. The method of claim 13, wherein the aqueous polyurethane dispersion comprises surfactants.

26. The method of claim 25, wherein the surfactants comprise functional groups carried by the chain of the polyurethane.

27. The method of claim 25, wherein the surfactants comprise anionic polar groups.

28. The method of claim 13, wherein the polyurethane is self-crosslinkable.

29. The method of claim 13, wherein the concentration of polyurethane in the aqueous polyurethane dispersion is between 10 and 50% by weight.

30. The method of claim 13, wherein the polyurethane used in the aqueous polyurethane dispersion is prepared from a polyol selected from the group consisting of aliphatic polyethers, aliphatic polyesters, and polyethers and polyesters whose main chain is semi-aromatic, wherein the polyurethane has a glass transition temperature of less than or equal to −20° C. and an elongation at break of greater than or equal to 100%.
